(19) United States
(12) Patent Application Publication
(10) Pub. No.: US 2024/0299794 A1
(43) Pub. Date: Sep. 12, 2024

(54) ELECTRICAL EQUIPMENT

(71) Applicant: TOPPAN HOLDINGS INC., Tokyo (JP)

(72) Inventors: Junya TANABE, Tokyo (JP); Masato KUROKAWA, Tokyo (JP); Yasuharu SHIINE, Tokyo (JP)

(73) Assignee: TOPPAN HOLDINGS INC., Tokyo (JP)

(21) Appl. No.: 18/654,578

(22) Filed: May 3, 2024

Related U.S. Application Data
(63) Continuation of application No. PCT/JP2022/039755, filed on Oct. 25, 2022.

(30) Foreign Application Priority Data
Nov. 4, 2021 (JP) 2021-180006

(51) Int. Cl. A62D 1/06; A62D 1/00

(52) U.S. Cl. CPC A62D 1/06; A62D 1/0014

(57) ABSTRACT

Electrical equipment including at least one electrical device and a housing that houses the at least one electrical device, wherein a fire extinguisher is provided to at least part of an inner wall of the housing to face the at least one electrical device; and the fire extinguisher includes a fire extinguishing material obtained by molding a composition that contains a fire extinguishing agent and a binder.

### CROSS-REFERENCE TO RELATED PATENT APPLICATIONS

This application is a continuation application filed under 35 U.S.C. § 111(a) claiming the benefit under 35 U.S.C. §§ 120 and 365(c) of International Patent Application No. PCT/JP2022/039755, filed on Oct. 25, 2022, which is based upon and claims the benefit to Japanese Patent Application No. 2021-180006 filed on Nov. 4, 2021, the disclosures of which are incorporated herein by reference in their entirety.

### BACKGROUND

### Technical Field

The present invention relates to electrical equipment.

### SUMMARY OF THE INVENTION

### Background Art

Electrical equipment such as switchboards, distribution panels, and control panels can cause fires due to short circuits, sparks, insulation deterioration, electrical leakage, etc.

To address the problems of ignition and fire, PTL 1 proposes to use a fire extinguishing liquid and fire extinguishing device. PTL 2 proposes an aerosol fire extinguishing system.

[Citation List] [Patent Literature] PTL 1: JP H9-276440 A; PTL 2: JP 2017-080023 A.

### Technical Problem

These conventional techniques all propose methods of dealing with fire after the lapse of some time. However, from the perspective of minimizing damage due to fire, it is desirable that some kind of fire extinguishing work (initial fire extinction) be performed on the electrical equipment shortly after ignition.

The present invention has been made in light of the circumstances set forth above and aims to provide electrical equipment which is able to prevent occurrence and spread of fire and has higher initial fire extinguishability.

### Solution to Problem

An aspect of the present invention provides electrical equipment including at least one electrical device and a housing that houses the at least one electrical device, wherein a fire extinguisher is provided to at least part of an inner wall of the housing so as to face the at least one electrical device; and the fire extinguisher includes a fire extinguishing material obtained by molding a composition that contains a fire extinguishing agent and a binder. With this electrical equipment, the fire extinguisher extinguishes fire at a stage shortly after ignition. This can prevent occurrence and spread of fire.

According to an aspect, the distance between the at least one electrical device and the fire extinguisher may be 150 mm or less.

According to an aspect, the fire extinguishing agent may contain at least either of an organic salt and an inorganic salt, and the binder may contain at least either of a polyvinyl acetal resin and a polyvinyl alcohol resin.

According to an aspect, the fire extinguishing material may contain 70 to 97 mass % of the salt relative to the total mass of the salt and the resin.

According to an aspect, the salt may be a potassium salt.

According to an aspect, the fire extinguisher may include an adhesion layer, and the fire extinguisher may be provided to the inner wall via the adhesion layer.

### Advantageous Effects of the Invention

According to the present invention, there can be provided electrical equipment which is able to prevent occurrence and spread of fire and has higher initial fire extinguishability.

Advantages of the present invention are briefly summarized below. Damage due to spread of flames can be minimized. After a person confirms the occurrence of a fire, there is no need for the person to carry a fire extinguishing device to the vicinity of the target fire area to perform fire extinguishing work. Compared to equipment such as an automatic fire extinguishing system or the like, the electrical equipment of the present disclosure can be easily installed, has little restriction on installation location, and can be applied according to the location where needed.

### BRIEF DESCRIPTION OF THE DRAWINGS

FIG. 1 is a schematic external view illustrating a fire extinguisher according to an embodiment.

FIG. 2 is a schematic cross-sectional view illustrating a fire extinguisher according to an embodiment.

FIG. 3 is a schematic external view illustrating electrical equipment according to an embodiment.

### DETAILED DESCRIPTION

Embodiments of the present invention will be described in detail below. It should be noted that the present invention should not be construed as being limited to the following embodiments.

### <Fire Extinguisher>

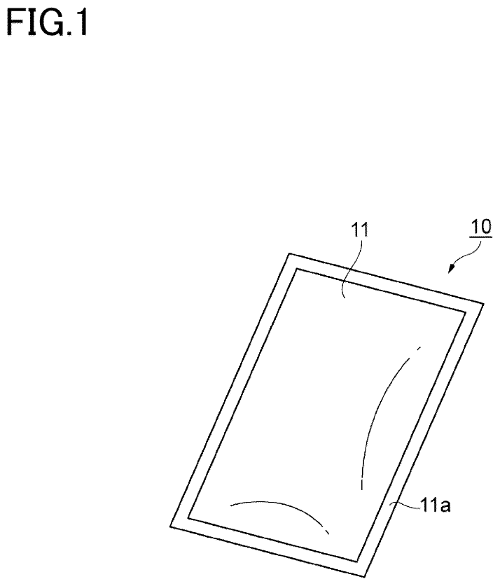

FIG. 1 is a schematic external view illustrating a fire extinguisher according to an embodiment. A fire extinguisher 10 includes a packaging bag 11 formed of a base material, and a fire extinguishing material sealed in the packaging bag. The packaging bag 11 includes a sealing part 11a on the periphery thereof. In the sealing part 11a, surfaces of the base material are joined with each other. The fire extinguishing material does not have to be sealed in the packaging bag, but may be used itself as a fire extinguisher.

When the fire extinguisher is viewed perpendicularly from above, the width of the sealing part 11a is not specifically limited but, from the perspective of property stability of fire extinguishing agent, the width can be, for example, 2 to 40 mm.

The thickness of the fire extinguisher at the center portion may vary due to the layer configuration or the amount of the fire extinguishing material to be sealed therein. Therefore, the thickness is not necessarily limited but can be, for example, 2 to 20 mm from the perspective of maintaining fire extinguishability and achieving a reduced thickness that does not raise an issue of installation space. Furthermore, the major surface of the fire extinguisher (the surface of the fire extinguisher as viewed perpendicularly from above) can have an area, for example, of 9 to 620 cm² from the perspective of fire extinguishing performance and handleability.

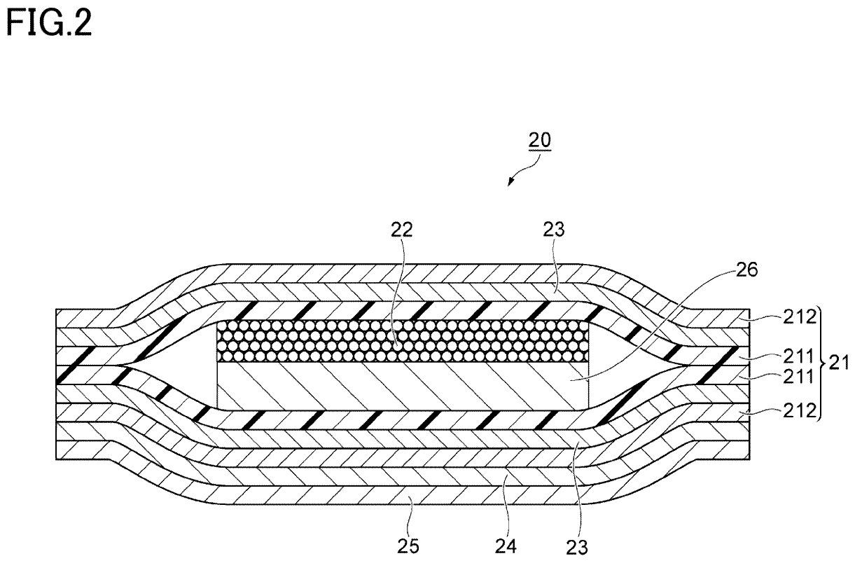

FIG. 2 is a schematic cross-sectional view illustrating a fire extinguisher according to an embodiment. A fire extinguisher 20 includes a packaging bag 21 formed of a base material, a fire extinguishing material 22 sealed in the packaging bag, and an adhesion layer 24 (or adhesive layer) and a release film 25 both provided on one surface of the packaging bag. The base material includes a first resin layer 211 as an inner layer having heat melting properties, and a second resin layer (e.g., water vapor barrier layer) 212 as an outer layer. The first resin layer 211 and the second resin layer 212 are laminated with each other via an adhesive layer 23. The fire extinguishing material 22 is formed on a support layer 26. In the present embodiment, since the adhesion layer 24 is provided on one surface of the packaging bag, the fire extinguisher can be installed on an inner wall of the housing of electrical equipment according to the placement of electrical devices. The release film 25, which is provided covering the adhesion layer 24 and peeled off when attaching the fire extinguisher to a desired location, may be made of a resin or paper.

The fire extinguisher may additionally include a design layer. The design layer can be formed by printing. Specific examples of the design include white and gray solid patterns such as wood-grain and tile-like patterns for living spaces, and pictorial patterns, printed patterns, designs, and character patterns. Provision of the design layer can exert such effects as enhancing aesthetic properties, allowing the fire extinguisher to blend in with its surroundings, and enhancing strength of the fire extinguisher. For example, in the mode shown in FIG. 2, the design layer can be provided on one side of the packaging bag opposite to the side provided with the adhesion layer (that is the side through which the fire extinguisher is attached to the inner wall). If the layers included in the base material are transparent, the design layer may be provided inside the base material. For example, in the mode shown in FIG. 2, the design layer may be provided on the inside of the second resin layer 212. The design layer may have a single-layer structure or a multilayer structure.

### (Base Material)

The base material includes a resin layer. Examples of the material of the resin layer include polyolefins (PE, PP, COP, etc.), polyesters (PET, etc.), fluororesins (PTFE, ETFE, EFEP, PFA, FEP, PCTFE, etc.), vinyl resins (PVC, PVA, etc.), acrylic resins, epoxy resins, polyamides, and polyimides. The base material may be structured by a single resin layer or multiple resin layers made of these materials. The multiple resin layers may be made of respective materials different from each other. If the base material is structured by multiple layers, these layers may be adhered to each other via an adhesive (adhesive layer). Examples of the adhesive include acrylic adhesives, epoxy adhesives, silicone adhesives, polyolefin adhesives, urethane adhesives, and polyvinyl ether adhesives, and synthetic adhesives thereof. A resin layer whose melting point is not excessively high may be provided to serve as an outermost layer of the base material (may be provided on the side facing the electrical devices), from the perspective of the resin layer being easily melted due to heat from fire and easily applying heat to the extinguishing agent. Such a layer may be a polyolefin layer. For example, a layer made of PE (melting point: 137° C.) or PP (melting point 163° C.) has a melting point lower than a layer made of PET (melting point 265° C.). Such a polyolefin layer can be preferably used for fire in a switchboard etc. which spreads gradually after ignition (which is not an explosive fire).

The resin layer may have heat melting properties (heat fusibility). The resin layer having heat melting properties can be referred to as a hot-melt layer. Such a hot-melt layer can be provided to serve as an innermost layer of the base material (can be provided on the side facing the fire extinguishing material). If the base material includes a hot-melt layer, the sealing part on the periphery of the packaging bag can be referred to as a heat-seal part. Resins having heat melting properties may be polyolefin resins. In other words, the resin layer may contain a polyolefin resin. Examples of such a polyolefin resin include polyolefin resins such as low-density polyethylene resins (LDPE), linear low-density polyethylene resins (LLDPE), medium-density polyethylene resins (MDPE), and unstretched polypropylene resins (CPP), polyethylene resins such as ethylene/vinyl acetate copolymers, and ethylene/α-olefin copolymers, and polypropylene resins such as propylene/ethylene random copolymers, propylene/ethylene block copolymers, and propylene/α-olefin copolymers. Of these, the polyolefin resin may preferably be a low-density polyethylene resin (LDPE), linear low-density polyethylene resin (LLDPE), or unstretched polypropylene resin (CPP), from the perspective of having good heat sealability and low water vapor permeability, and easily preventing deterioration of the fire extinguishing agent. These resins having transparency make it easy to visually inspect the fire extinguishing agent. Therefore, it becomes easier to check when to replace the fire extinguisher.

If no hot-melt layer is provided, surfaces of the base material can be joined together using an adhesive. Examples of the adhesive include acrylic adhesives, epoxy adhesives, silicone adhesives, polyolefin adhesives, urethane adhesives, and polyvinyl ether adhesives, and synthetic adhesives thereof. Of these, epoxy-urethane synthetic adhesives can be preferably used as the adhesive, from the perspective of adhesion with the base material in an 85° C.-85% RH high temperature and high humidity environment and cost reduction.

When joining surfaces of the base material together on the periphery thereof using an adhesive, the sealing part on the periphery of the packaging bag can be referred to as an adhesive part.

The base material may include a water vapor barrier layer. The water vapor barrier layer may be provided as an outermost layer of the base material or may be provided as an intermediate layer of the base material. If the base material includes a water vapor barrier layer, water vapor barrier properties of the fire extinguisher can be easily maintained at a level of not significantly changing the properties of the fire extinguishing agent, regardless of the installation location or usage environment of the fire extinguisher. Water vapor permeability of the water vapor barrier layer (under 40° C.-90% RH according to JIS K 7129), which can be designed according to the type of the fire extinguishing agent, is not specifically limited but may preferably be 10 g/m2/day or less, and more preferably be 1 g/m2/day or less. From the perspective of water vapor permeability adjustment, the water vapor barrier layer may be a polyester resin layer (e.g., PET layer) including a metal oxide deposition layer such as an alumina deposition layer or silica deposition layer, or a metal foil such as an aluminum foil. If the water vapor barrier layer includes a metal oxide deposition layer, the metal oxide deposition layer may be located facing the fire extinguishing agent.

The thickness of the base material can be adequately selected according to the usage environment of the fire extinguisher, space allowed, or the like. For example, a thick base material can easily suppress water vapor permeation, can easily obtain strength or rigidity, can easily attain a highly flat form, or can be easily handled. A thin base material may allow fire extinguisher to be placed in a narrow space. The thickness of the base material may preferably be, for example, 4.5 to 1,000 μm, more preferably be 12 to 100 μm, and even more preferably be 12 to 50 μm. The thicknesses of the resin layer and the water vapor barrier layer may be adequately adjusted according to the thickness of the base material. The thickness of the resin layer (total thickness if the base material includes multiple layers) may preferably be, for example, 25 to 150 μm, and more preferably be 30 to 100 μm. The thickness of the water vapor barrier layer may preferably be, for example, 4.5 to 25 μm, and more preferably be 7 to 12 μm.

### <Fire Extinguishing Material>

The fire extinguishing material is obtained by molding a composition containing a fire extinguishing agent and binder (fire extinguishing material-forming composition). By forming the fire extinguishing material using a binder, the properties of the fire extinguishing material can be easily maintained, and the frequency of replacing the fire extinguisher can be reduced. The fire extinguishing material-forming composition may further contain a liquid medium in addition to the above resin and binder.

### (Fire Extinguishing Agent)

The fire extinguishing agent can extinguish fire by producing an aerosol through combustion. The fire extinguishing agent can contain at least either of an organic salt and an inorganic salt. The organic salt or inorganic salt may be a salt with hygroscopic properties.

Examples of the organic salt functioning as the fire extinguishing agent include potassium salts, sodium salts, and ammonium salts. A potassium salt can be preferably used as the organic salt. Examples of the organic potassium salt include carboxylic acid potassium salts such as potassium acetate, potassium citrate (tripotassium citrate), potassium tartrate, potassium lactate, potassium oxalate, and potassium maleate. Of these, potassium acetate or potassium citrate can be preferably used from the perspective of utility for negative catalytic effects on combustion.

Examples of the inorganic salt functioning as the fire extinguishing agent include potassium salts and sodium salts. A potassium salt can be preferably used as the inorganic salt. Examples of the inorganic potassium salt include potassium chlorate, potassium tetraborate, potassium carbonate, potassium hydrogen carbonate, potassium dihydrogen phosphate, and dipotassium hydrogen phosphate. Of these, potassium hydrogen carbonate can be preferably used from the perspective of utility for negative catalytic effects on combustion.

The organic or inorganic salt may be used singly or in combination of two or more.

The organic or inorganic salt may be granulated. The organic or inorganic salt may preferably have an average particle size D50 of 1 to 100 μm, and more preferably 3 to 40 μm. With the average particle size D50 being the above lower limit or more, the salt may be easily dispersed in the system, and with the average particle size D50 being the above upper limit or less, stability tends to be improved when used as a coating liquid to improve smoothness of the coated surface. The average particle size D50 can be calculated through wet measurement using a laser diffraction particle size distribution measuring device.

The amount of the salt (organic or inorganic salt) may preferably be 70 to 97 mass %, and more preferably be 85 to 92 mass % relative to the total mass of the salt and resin (polyvinyl acetal resin or polyvinyl alcohol resin described later). With the amount of the salt being the above upper limit or less, a uniform fire extinguishing material can be easily formed, and with the amount of the salt being the above lower limit or more, moisture absorption of the salt can be more easily suppressed and sufficient fire extinguishing properties can be more easily maintained. The total mass of the salt and resin can also be referred to as the total mass of the fire extinguishing agent and binder, although it depends on the components contained.

Content of the organic or inorganic salt in the fire extinguishing agent may preferably be 60 mass % or more, more preferably be 90 mass % or more, and even more preferably be 100 mass % relative to the total mass of the fire extinguishing agent, from the perspective of exhibiting a fire extinguishing function.

The fire extinguishing agent may contain other components than the salts mentioned above. Examples of the other components include colorants, oxidants, antioxidants, flame retardants, inorganic fillers, flow enhancers, moisture-proof agents, dispersants, and UV absorbers. These other components can be adequately selected according to the type of the salt and the type of the binder. Content of the other components in the fire extinguishing agent may be, for example, 40 mass % or less.

### (Binder)

The binder can contain at least either of a polyvinyl acetal resin and a polyvinyl alcohol resin. Polyvinyl acetal resins and polyvinyl alcohol resins are both hydroxyl group-containing resins. Polyvinyl acetal resins can easily suppress moisture absorption of the salt because the higher the degree of acetalization, the more hydrophobic the resin becomes. Polyvinyl alcohol resins, although they have many hydroxyl groups compared to polyvinyl acetal resins, are considered to have many reaction points with other resin components than the resins mentioned above because of not being acetalized. Therefore, from the perspective of binder designing, polyvinyl alcohol resins have higher design flexibility and can be more easily handled.

Polyvinyl alcohol resins are obtained by saponifying polyvinyl acetate resins. Examples of polyvinyl acetate resins include polyvinyl acetate, which is a homopolymer of vinyl acetate, and copolymers of vinyl acetate and other monomers. Examples of the other monomers include unsaturated carboxylic acids, unsaturated sulfonic acids, olefins, vinyl ethers, and acrylamides having ammonium groups.

Saponification degree of such a polyvinyl alcohol resin is not specifically limited but may preferably be 80 mol % or more, and more preferably be 95 mol % or more. With the polyvinyl alcohol resin having an appropriate saponification degree, adhesion with the salt can be easily improved and moisture absorption of the salt can be easily suppressed.

The polyvinyl alcohol resin may be modified. Examples of the modification include acetoacetyl group modification, carboxylic acid modification, carbonyl group modification, sulfonic acid modification, hydrazide group modification, thiol group modification, alkyl group modification, silyl group modification, polyethylene glycol group modification, ethylene oxide group modification, modification with a group having a urethane bond, and phosphate ester group modification. With the polyvinyl alcohol resin modified, adhesion with the salt can be easily improved, and moisture absorption of the salt can be easily suppressed.

Polyvinyl acetal resins are obtained by acetalizing polyvinyl alcohol resins.

Saponification degree of such a polyvinyl alcohol resin used for obtaining a polyvinyl acetal resin is not specifically limited but may preferably be 80 mol % or more, and more preferably be 95 mol % or more.

Aldehydes used for acetalization are not specifically limited but examples thereof include aldehydes having aliphatic groups or aromatic groups having 1 to 10 carbon atoms. Examples of the aldehydes include aliphatic aldehydes such as formaldehyde, acetaldehyde, propionaldehyde, n-butyraldehyde, isobutyraldehyde, n-valeraldehyde, n-hexylaldehyde, 2-ethylbutyraldehyde, 2-ethylhexylaldehyde, n-heptylaldehyde, n-octylaldehyde, n-nonylaldehyde, n-decylaldehyde, and amylaldehyde; and aromatic aldehydes such as benzaldehyde, cinnamaldehyde, 2-methylbenzaldehyde, 3-methylbenzaldehyde, 4-methylbenzaldehyde, p-hydroxybenzaldehyde, m-hydroxybenzaldehyde, phenylacetaldehyde, and β-phenylpropionaldehyde. These aldehydes may be used singly or in combination of two or more. Of these aldehydes, butyraldehyde, 2-ethylhexylaldehyde, or n-nonylaldehyde may be preferable, and butyraldehyde may be more preferable, from the perspective of having good acetalization reactivity.

Ketones used for acetalization are not specifically limited but examples thereof include acetone, ethyl methyl ketone, diethyl ketone, t-butyl ketone, dipropyl ketone, allyl ethyl ketone, acetophenone, p-methylacetophenone, 4′-aminoacetophenone, p-chloroacetophenone, 4′-methoxyacetophenone, 2′-hydroxy acetophenone, 3′-nitroacetophenone, P-(1-piperidino)acetophenone, benzalacetophenone, propiophenone, benzophenone, 4-nitrobenzophenone, 2-methylbenzophenone, p-bromobenzophenone, cyclohexyl(phenyl)methanone, 2-butyronaphthone, 1-acetonaphthone, 2-hydroxy-1-acetonaphthone, and 8′-hydroxy-1′-benzonaphthone.

The amount of use of the aldehyde and ketone can be adequately determined according to the degree of acetalization. For example, with respect to the hydroxyl groups of a polyvinyl alcohol resin before reaction, the total mass of the aldehyde and ketone can be 0.30 to 0.45 hydroxyl equivalents.

The hydroxyl equivalent (residual hydroxyl value) of the polyvinyl acetal resin may preferably be 10 to 40 mol %, and more preferably be 15 to 25 mol %. If the hydroxyl equivalent is in the above range, the aliphatic and aromatic groups of the aldehyde and ketone can provide hydrophobicity, and the rate of moisture absorption tends to slow down. The amount of hydroxyl groups is the ratio (mol %) of the amount of ethylene groups to which hydroxyl groups are bonded, to the total amount of ethylene groups in the main chain. The amount of ethylene groups to which hydroxyl groups are bonded can be calculated, for example, using a method according to JIS K 6728 “Testing methods for polyvinyl butyral”.

The polyvinyl acetal resin or polyvinyl alcohol resin may be used singly or in combination or two or more.

The polyvinyl acetal resin or polyvinyl alcohol resin may preferably have a weight average molecular weight Mw of 10,000 or more, and more preferably 20,000 or more, and preferably have a weight average molecular weight Mw of 150,000 or less, and more preferably 100,000 or less. With the weight average molecular weight Mw being the above lower limit or more, it may be easy to ensure hydrophobicity of the resin, and with the weight average molecular weight Mw being the above upper limit or less, it may be easy to ensure appropriate resin flexibility and it may be easy to improve bending resistance or coating suitability. The weight average molecular weight Mw can be calculated using a GPC method.

The polyvinyl acetal resin or polyvinyl alcohol resin may preferably have a glass transition temperature Tg of 55° C. or more, and more preferably 80° C. or more, and may preferably have a glass transition temperature Tg of 110° C. or less, and more preferably 100° C. or less. With the glass transition temperature Tg being the above lower limit or more, it may be easy to ensure hydrophobicity of the resin due to increase in crystallinity, and with the glass transition temperature Tg being the above upper limit or less, it may be easy to improve coating suitability. The glass transition temperature Tg can be measured through thermal analysis using a differential scanning calorimeter.

From the perspective of sufficiently exhibiting the characteristics of the polyvinyl acetal resin or polyvinyl alcohol resin, content of the resin in the binder may preferably be 40 mass % or more, more preferably be 70 mass % or more, and even more preferably be 100 mass %.

From the perspective of suppressing moisture absorption of the salt due to improvement in hydrophobicity, the binder may contain other components than the resins mentioned above. Examples of the other components include silane coupling agents. Content of the other components in the binder may be, for example, 60 mass % or less.

### (Liquid Medium)

Examples of the liquid medium include organic solvents. The organic solvents may be water-soluble solvents, examples of which include alcohols such as methanol, ethanol, isopropyl alcohol, and n-propyl alcohol; ketones such as acetone and methyl ethyl ketone; glycols such as ethylene glycol and diethylene glycol; and glycol ethers such as N-methylpyrrolidone (NMP), tetrahydrofuran, and butyl cellosolve. From the perspective that the fire extinguishing agent may have hygroscopic properties, the liquid medium may preferably be an alcohol solvent and, specifically, may be a mixed solvent of ethanol and isopropyl alcohol.

The amount of the liquid medium may be adequately adjusted according to the method of using the fire extinguishing material-forming composition but may preferably be 40 to 95 mass % relative to the total mass of the fire extinguishing material-forming composition. The fire extinguishing material-forming composition containing such a liquid medium can be referred to as a fire extinguishing material-forming coating liquid.

### <Method of Forming Fire Extinguishing Material>

The fire extinguishing material can be formed by applying a fire extinguishing material-forming coating liquid onto a support layer, followed by drying. The support layer may be a polyester resin layer (e.g., PET layer).

Coating may be performed using a wet coating method. Examples of the wet coating method include a gravure coating method, comma coating method, spray coating method, dip coating method, curtain coating method, spin coating method, sponge roll method, die coating method, and coating using a brush.

The fire extinguishing material-forming coating liquid may preferably have a viscosity of 1 to 2,000 mPa·s if, for example, a gravure coating method is used, 500 to 100,000 mPa·s if a comma coating method is used, and 0.1 to 4,000 mPa·s if a spray coating method is used. The amount of the above liquid medium may be adequately adjusted so that the viscosity of the coating liquid will be in a desired range. Viscosity can be measured using a coaxial double-cylinder rotational viscometer.

The fire extinguishing material can also be obtained by molding a fire extinguishing material-forming composition.

The fire extinguishing material reacts to heat generated by ignition and automatically extinguishes the fire. Accordingly, the fire extinguishing material can be referred to as a self-extinguishing fire extinguishing material (the material obtained by molding can be referred to, in particular, as a self-extinguishing molded material).

### <Electrical Equipment>

The electrical equipment includes electrical devices and a housing for accommodating the electrical devices. At least part of the inner wall of the housing is provided with the fire extinguisher described above so as to face the electrical devices. The inner wall of the housing includes a back surface, front surface, side surfaces, top surface, and wiring cover of the housing. The electrical equipment includes power receiving and transforming equipment such as a switchboard and distribution board, and equipment such as an operation panel and control panel for production devices, etc. The electrical devices include terminal blocks, transformers, breakers, capacitors, earth leakage circuit breakers, electrical wiring, etc. provided on these boards and panels. These electrical devices can be referred to as parts where there is a risk of ignition in the electrical equipment. The electrical equipment commonly includes multiple electrical devices. The fire extinguisher may be provided to at least one of the electrical devices or may be provided to each of all the electrical devices. Alternatively, one fire extinguisher may be provided to face multiple electrical devices. Occurrence and spread of fire can be prevented by providing in advance the fire extinguisher having higher initial fire extinguishability in the electrical equipment.

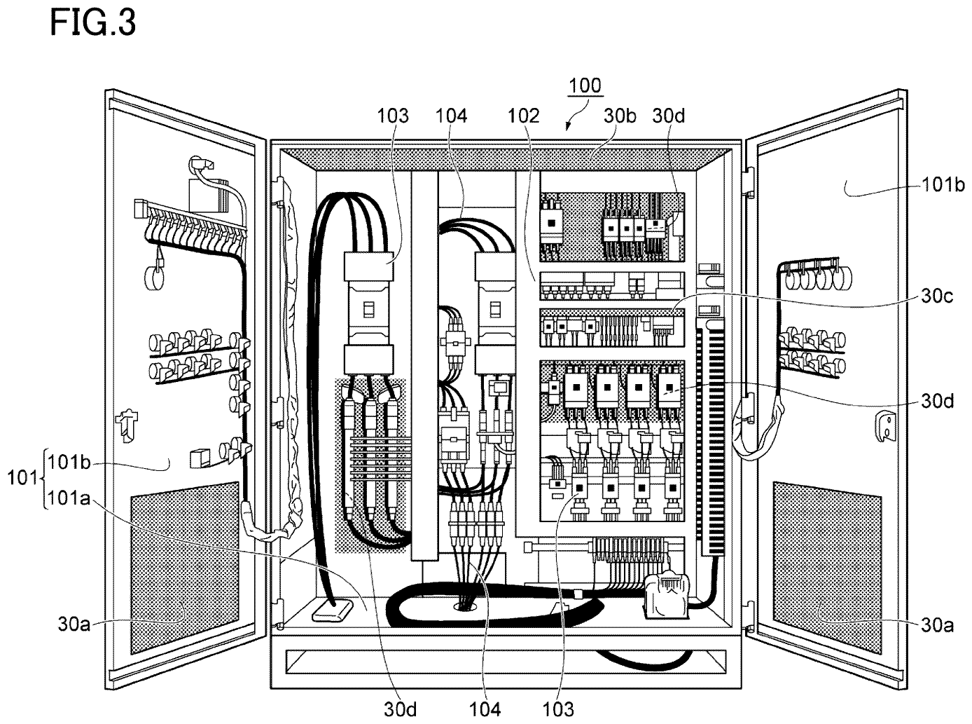

FIG. 3 is a schematic external view illustrating electrical equipment according to an embodiment. FIG. 3 shows a switchboard as an example of the electrical equipment. Electrical equipment 100 mainly includes a housing 101 including an accommodation section 101a to accommodate electrical devices and a door 101b and includes breakers 103 and wiring 104 as electrical devices. Part of the wiring 104 is collectively accommodated in a wiring cover 102. In such electrical equipment 100, for example, a fire extinguisher 30a can be provided to the door 101b so as to face the electrical devices, a fire extinguisher 30b can be provided to the top surface of the accommodation section 101a so as to face the electrical devices, a fire extinguisher 30c can be provided to the lower surface of the wiring cover 102 so as to face the electrical devices (only approximate installation locations are shown in the diagram for simplicity), and a fire extinguisher 30d can be provided to the back surface of the accommodation section 101a so as to face the electrical devices, i.e., behind the electrical devices. The electrical equipment 100 may be provided with all of these fire extinguishers or may be provided with at least one of them.

The positions for arranging the fire extinguishers are not limited to the positions shown in FIG. 3. The positions can be adequately adjusted according to the arrangement of the electrical devices, etc. that are the parts having a risk of ignition. If the distance between each of the fire extinguishers and the electrical devices is large, a member for adjusting the distance may be provided first and then the fire distinguisher may be provided on the member.

The distance between each of the electrical devices and the fire extinguisher can be adequately adjusted, but may preferably be 150 mm or less, more preferably be 120 mm or less, and even more preferably be 100 mm or less. Thus, initial fire extinction can be performed more appropriately. The distance between each of the electrical devices and the fire extinguisher refers to a minimum distance between the electrical device and the fire extinguisher provided facing the electrical device. For example, for an electrical device located at a distance of 150 mm or less from the top surface of the accommodation section 101a, that is, located right beneath the top surface, the fire extinguisher can be provided on the top surface. Also, for an electrical device located at a position facing the door 101b, that is, located at a distance of 150 mm or less from the door 101b, the fire extinguisher can be provided on the door 101b. It is desirable that the fire extinguisher is installed at a position near the electrical device; however, if the distance is excessively small, both may be in contact with each other, and therefore, the distance between both may preferably be at least 1 mm or more.

### EXAMPLES

The present invention will be described in more detail using the following examples, but the present invention should not be limited to these examples.

### <Preparation of Fire Extinguisher>

The following main basic materials were used. The average particle size D50 of tripotassium citrate was adjusted by grinding it in an agate mortar and then filtering it with a No. 800 mesh.

Tripotassium citrate: Tripotassium citrate monohydrate (product name), D50=3 to 18 μm, manufactured by FUJIFILM Wako Chemicals

Polyvinyl butyral: Weight average molecular weight (calculated value) Mw: 20,000 to 100,000, Amount of hydroxyl groups: 15 to 25 mol %, Glass transition temperature Tg: 80 to 100° C.

A coating liquid (fire extinguishing material-forming coating liquid) was prepared, containing 25 mass % of tripotassium citrate-containing potassium salt, 8 mass % of polyvinyl butyral, and 67 mass % of ethanol solvent. The obtained coating liquid was applied to a polyethylene terephthalate (PET) film using an applicator (gap 750 μm), followed by drying in an oven at 100° C. for 4 minutes. Thus, a fire extinguisher was obtained in which a fire extinguishing material with a thickness of 200 μm was formed on a PET film. The obtained fire extinguisher was cut to a 100 mm×150 mm size and subjected to the following fire extinguishing testing.

### <Fire Extinguishing Testing>

### Example 1

An iron housing was prepared with a width of 400 mm, height of 600 mm, and depth of 200 mm. The housing was provided with a glass door so that the inside of the hosing can be checked. To prevent the ignited solid fuel from extinguishing due to lack of oxygen, 20 openings were provided on both sides of the housing for air introduction. The diameter @ of each opening was 10 mm. Next, a support member was provided at the center of the back surface of the housing, and a terminal block was provided on the support member. The fire extinguisher was attached to the back surface of the housing using a double-sided tape at a position facing the terminal block so that the fire extinguishing material surface of the fire extinguisher would be opposed to the terminal block. The distance between the terminal block and the fire extinguisher was 4 mm. Then, 5 g of solid fuel was placed on the terminal block, ignited with a lighter, and the door of the housing was closed. Approximately 7 seconds after the door was closed, the fire was extinguished by the fire extinguishing material.

### Example 2

A terminal block was installed in a housing as in Example 1. The fire extinguisher was attached to the top surface of the housing using a double-sided tape at a position facing the terminal block so that the fire extinguishing material surface of the fire extinguisher would be opposed to the terminal block. The distance between the terminal block and the fire extinguisher was 150 mm. Then, 5 g of solid fuel was placed on the terminal block, ignited with a lighter, and the door of the housing was closed. Approximately 28 seconds after the door was closed, the fire was extinguished by the fire extinguishing material.

[Reference Signs List] 10, 20, 30a, 30b, 30c, 30d . . . Fire extinguisher; 11, 21 . . . Packaging bag; 11a . . . Sealing part; 211 . . . First resin layer; 212 . . . Second resin layer; 22 . . . Fire extinguishing material; 23 . . . Adhesive layer; 24 . . . Adhesion layer; 25 . . . Release film; 26 . . . Support layer; 100 . . . Electrical equipment (switchboard); 101 . . . Housing; 101a Accommodation section; 101b . . . Door; 102 . . . Wiring cover; 103 . . . Breaker; 104 . . . Wiring.

What is claimed is:

1. Electrical equipment, comprising: at least one electrical device and a housing that houses the at least one electrical device, wherein
a fire extinguisher is provided to at least part of an inner wall of the housing so as to face the at least one electrical device; and
the fire extinguisher includes a fire extinguishing material obtained by molding a composition that contains a fire extinguishing agent and a binder.

2. The electrical equipment of claim 1, wherein a distance between the at least one electrical device and the fire extinguisher is 150 mm or less.

3. The electrical equipment of claim 1, wherein the fire extinguishing agent contains at least either of an organic salt and an inorganic salt, and the binder contains at least either of a polyvinyl acetal resin and a polyvinyl alcohol resin.

4. The electrical equipment of claim 3, wherein the fire extinguishing material contains 70 to 97 mass % of the salt relative to a total mass of the salt and the resin.

5. The electrical equipment of claim 3, wherein the salt is a potassium salt.

6. The electrical equipment of claim 1, wherein the fire extinguisher includes an adhesion layer, and the fire extinguisher is provided to the inner wall via the adhesion layer.
